(19) United States
(12) Patent Application Publication
(10) Pub. No.: US 2016/0080637 A1
(43) Pub. Date: Mar. 17, 2016

(54) CALIBRATION METHOD, NON-TRANSITORY RECORDING MEDIUM, AND CALIBRATION DEVICE

(71) Applicant: KABUSHIKI KAISHA TOSHIBA, Tokyo (JP)

(72) Inventors: Tsuyoshi TASAKI, Yokohama (JP); Tomoki WATANABE, Tokyo (JP)

(21) Appl. No.: 14/853,232

(22) Filed: Sep. 14, 2015

(30) Foreign Application Priority Data
Sep. 17, 2014 (JP) 2014-188625

(51) Int. Cl. H04N 5/232

(52) U.S. Cl. CPC H04N 5/23212; H04N 5/23238

(57) ABSTRACT

A calibration method includes acquiring a first image captured by an imaging device including a wide angle lens, extracting a part of the first image, and calibrating a parameter of the imaging device based on the part of the first image. A pattern surface, a first mirror surface provided on a first surface, and a second mirror surface provided on a second surface are projected to the first image. A calibration pattern is provided in the pattern surface. The first surface intersects the pattern surface. The second surface intersects the pattern surface and is parallel to the first surface. The pattern surface, a first mirror image of the pattern surface formed on the first mirror surface, and a second mirror image of the pattern surface formed on the second mirror surface appears in the part of the first image.

### CROSS-REFERENCE TO RELATED APPLICATIONS

This application is based upon and claims the benefit of priority from Japanese Patent Application No. 2014-188625, filed on Sep. 17, 2014; the entire contents of which are incorporated herein by reference.

### FIELD

Embodiments described herein relate generally to a calibration method, a non-transitory recording medium and a calibration device.

### BACKGROUND

The calibration of imaging parameters is performed for an imaging device using a wide angle lens. The imaging parameters are, for example, the focal length of the wide angle lens, the optical center of the image that is captured, etc. For such a calibration, a calibration method, a calibration program, and a compact calibration device that have high precision are desirable.

### BRIEF DESCRIPTION OF THE DRAWINGS

FIG. 1 is a schematic perspective view illustrating a calibration device according to a first embodiment;

FIG. 2 is a schematic side view illustrating the calibration device according to the first embodiment;

FIG. 3 is a block diagram illustrating the calibration device according to the first embodiment;

FIG. 4 is a flowchart illustrating the calibration method according to the first embodiment;

FIG. 5 is a schematic view illustrating the image of the calibration device according to the first embodiment;

FIG. 6 is a schematic perspective view illustrating a calibration device according to a second embodiment;

FIG. 7 is a schematic side view illustrating the calibration device according to the second embodiment;

FIG. 8 is a schematic plan view illustrating the calibration device according to the second embodiment;

FIG. 9 is a schematic view illustrating the image of the calibration device according to the second embodiment;

FIG. 10 is a schematic side view illustrating a calibration device according to a third embodiment;

FIG. 11 is a flowchart illustrating the calibration method according to the third embodiment; and

FIG. 12 is a schematic view illustrating the image that is captured by the calibration device according to the third embodiment.

### DETAILED DESCRIPTION

According to one embodiment, a calibration method includes acquiring a first image captured by an imaging device including a wide angle lens. At least a portion of a pattern surface is projected to the first image. At least a portion of a first mirror surface provided on a first surface is projected to the first image. At least a portion of a second mirror surface provided on a second surface is projected to the first image. A calibration pattern is provided in the pattern surface. The first surface intersects the pattern surface. The second surface intersects the pattern surface and is parallel to the first surface. The second mirror surface opposes the first mirror surface. The method includes extracting a part of the first image where the pattern surface is projected as a first pattern region. A first mirror image of the pattern surface formed on the first mirror surface appears in the first pattern region. A second mirror image of the pattern surface formed on the second mirror surface appears in the first pattern region. The method includes calibrating a parameter of the imaging device based on the first pattern region. The parameter includes a focal length of the wide angle lens.

According to one embodiment, a non-transitory recording medium records a calibration program of an imaging device including a wide angle lens. The program causes a computer to execute processing. The processing includes acquiring a first image captured by the imaging device. At least a portion of a pattern surface is projected to the first image. At least a portion of a first mirror surface provided on a first surface is projected to the first image. At least a portion of a second mirror surface provided on a second surface is projected to the first image. A calibration pattern is provided in the pattern surface. The first surface intersects the pattern surface. The second surface intersects the pattern surface and is parallel to the first surface. The second mirror surface opposes the first mirror surface. The processing includes extracting a part of the first image where the pattern surface is projected as a first pattern region. A first mirror image of the pattern surface formed on the first mirror surface appears in the first pattern region. A second mirror image of the pattern surface formed on the second mirror surface appears in the first pattern region. The processing includes calibrating a parameter of the imaging device based on the first pattern region. The parameter includes a focal length of the wide angle lens.

According to one embodiment, a calibration device includes a pattern surface, a first mirror surface, and a second mirror surface. A calibration pattern is provided in the pattern surface. The first mirror surface is provided on a first surface intersecting the pattern surface. The second mirror surface is provided on a second surface to oppose the first mirror surface. The second surface intersects the pattern surface and is parallel to the first surface. The device is capable of placing a wide angle lens of an imaging device at a position between the first mirror surface and the second mirror surface. The position is separated from the pattern surface. The device is used to calibrate a parameter of the imaging device based on a first image captured by the imaging device.

Various embodiments will be described hereinafter with reference to the accompanying drawings.

The drawings are schematic or conceptual; and the relationships between the thicknesses and widths of portions, the proportions of sizes between portions, etc., are not necessarily the same as the actual values thereof. There are also cases where the dimensions and/or the proportions are illustrated differently between the drawings, even in the case where the same portion is illustrated.

In the drawings and the specification of the application, components similar to those described in regard to a drawing thereinabove are marked with like reference numerals, and a detailed description is omitted as appropriate.

### FIRST EMBODIMENT

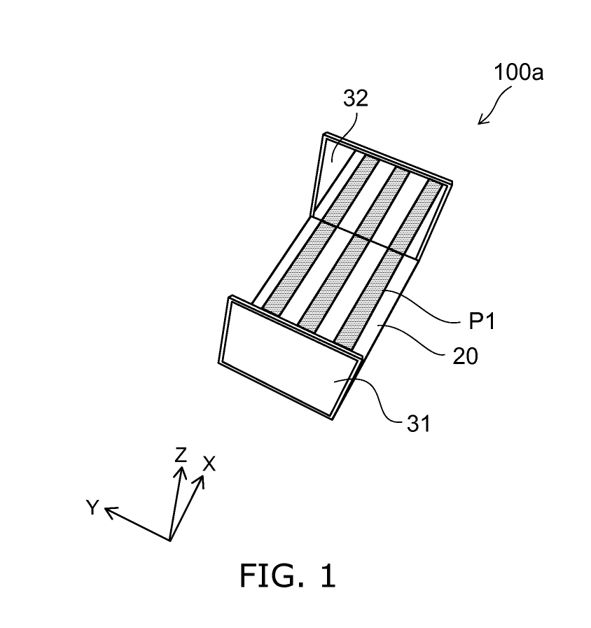

FIG. 1 is a schematic perspective view illustrating a calibration device according to a first embodiment.

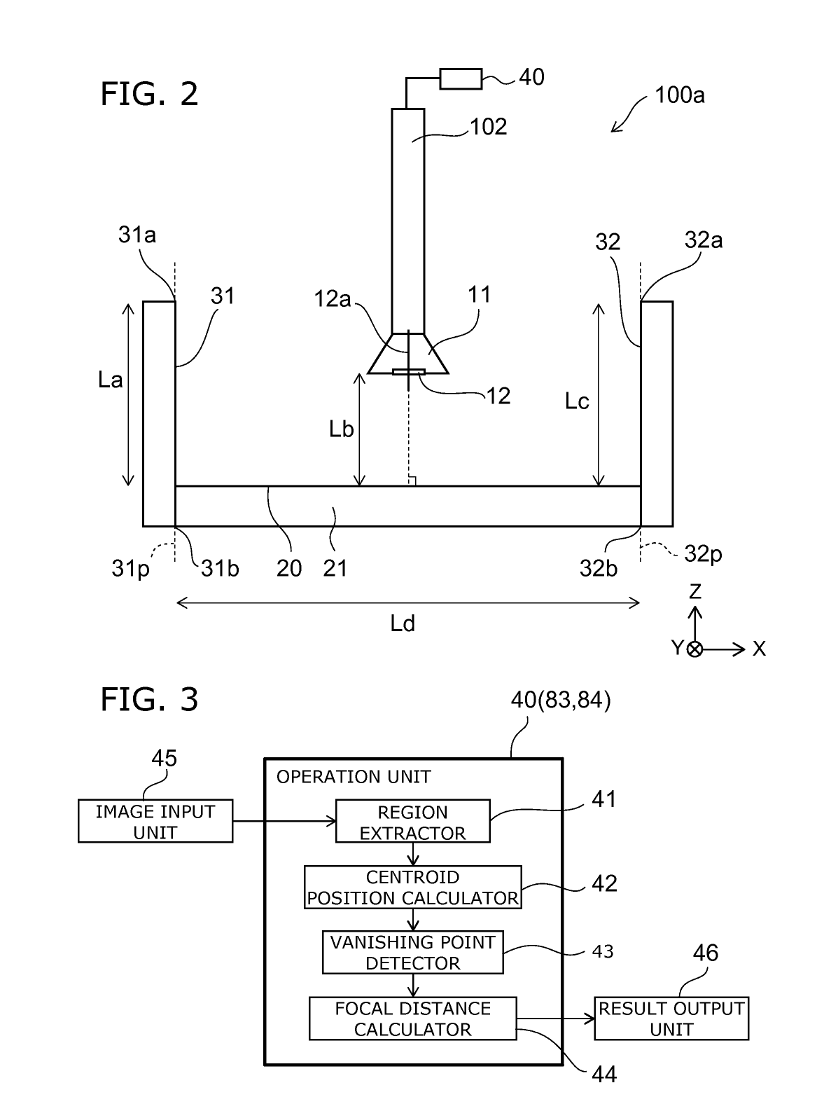

FIG. 2 is a schematic side view illustrating the calibration device according to the first embodiment.

The calibration device 100a shown in FIG. 1 and FIG. 2 is used in a calibration method of an imaging device according to the embodiment.

The calibration device 100a includes a pattern surface 20 in which a calibration pattern is provided, a first mirror surface 31, and a second mirror surface 32. The pattern surface 20 is a surface on a calibration board 21. The planar configuration of the calibration board is, for example, a rectangle.

As shown in FIG. 2, the first mirror surface 31 is provided on a first surface 31p intersecting the pattern surface 20. The second mirror surface 32 is provided on a second surface 32p intersecting the pattern surface 20.

Here, the first surface 31p may be considered to be an extension of the first mirror surface 31; and the second surface 32p may be considered to be an extension of the second mirror surface 32.

The second surface 32p is parallel to the first surface 31p. The second mirror surface 32 is separated from the first mirror surface 31 and is provided to oppose the first mirror surface 31.

The first mirror surface 31 and the second mirror surface 32 include, for example, plane mirrors. In the example, the first mirror surface 31, the second mirror surface 32, and the pattern surface 20 have planar configurations.

The first mirror surface 31 is disposed so that the second mirror surface 32 and the calibration pattern drawn on the pattern surface 20 appear in the first mirror surface 31.

The second mirror surface 32 is disposed so that the first mirror surface 31 and the calibration pattern drawn on the pattern surface 20 appear in the second mirror surface 32.

In other words, the first mirror surface 31 and the second mirror surface 32 are disposed as opposing mirrors. For example, the first mirror surface 31 is provided on one of two sides of the calibration board that face each other with the pattern surface 20 interposed; and the second mirror surface 32 is provided on the other of the two sides.

It is favorable for both the first mirror surface 31 and the second mirror surface 32 to substantially contact the pattern surface 20. Both the first mirror surface 31 (or the first surface 31p) and the second mirror surface 32 (or the second surface 32p) are substantially perpendicular to the pattern surface 20. A distance Ld between the first mirror surface 31 and the second mirror surface 32 is, for example, less than 1 meter.

A wide angle lens 12 of an imaging device 11 can be placed at a position that is separated from the pattern surface 20 between the first mirror surface 31 and the second mirror surface 32. In the example, the imaging device 11 is mounted to a placing unit 102. The angle of view of the wide angle lens 12 (a fisheye lens) is, for example, 180° or more.

The placing unit 102 regulates the position of the wide angle lens 12 with respect to the pattern surface 20.

It is desirable for the placing unit 102 not to be included in the angle of view of the wide angle lens 12. It is desirable for the placing unit 102 to be provided at a position where the placing unit 102 does not appear in the image (a first image) captured by the imaging device 11. For example, the placing unit 102 is an arm; and the imaging device 11 is suspended from the arm. Or, a line may be passed between the first mirror surface 31 and the second mirror surface 32; and the imaging device 11 may be suspended from the line.

The imaging device 11 and the wide angle lens 12 are provided so that at least a portion of the first mirror surface 31, at least a portion of the second mirror surface 32, and at least a portion of the pattern surface 20 appear in the image that can be captured. For example, the placing unit 102 places the imaging device 11 so that the first mirror surface 31, the second mirror surface 32, and the pattern surface 20 are contained within the range (the angle of view of the lens) that can be captured by the imaging device 11.

The first image is captured by the imaging device 11 including the wide angle lens 12 thus provided. The first image is an image to which at least a portion of the first mirror surface 31, at least a portion of the second mirror surface 32, and at least a portion of the pattern surface 20 are projected.

Based on such a first image, the calibration device 100a according to the embodiment is used to calibrate a parameter (extract a parameter) of the imaging device 11 and the wide angle lens 12. The parameter is, for example, the focal length of the wide angle lens 12, the position of the optical center of the image that is captured by the imaging device 11, etc.

When imaging the first image, illumination may be provided so that a shadow of the imaging device 11 and a shadow of the placing unit 102 do not appear.

The direction from the first mirror surface 31 toward the second mirror surface 32 is taken as an X-axis direction. A direction perpendicular to the X-axis direction and parallel to the pattern surface 20 is taken as a Y-axis direction. A direction perpendicular to the X-axis direction and perpendicular to the Y-axis direction is taken as a Z-axis direction. In the example, the Z-axis direction is perpendicular to the pattern surface 20.

The calibration pattern is drawn using at least one color. The calibration pattern may be a monochromatic plain pattern. For example, the brightness of the first image is ensured easily by using white monochrome.

It is favorable for the calibration pattern to include a pattern having a side p1 having a straight line configuration extending in the X-axis direction; and it is favorable for the calibration pattern to be drawn using two or more colors. It is favorable for the colors of the calibration pattern to be different from the color of the background (the region not including the image of the calibration device 100a) appearing in the first image. Thereby, the precision can be increased when detecting the vanishing points described below. In the example, the calibration pattern is a white and black fringe pattern.

The position where the wide angle lens 12 is provided will now be described.

As described above, the imaging device 11 is provided so that the first mirror surface 31, the second mirror surface 32, and the pattern surface 20 can be captured. Therefore, the wide angle lens 12 is provided inside a space partitioned by the first mirror surface 31, the second mirror surface 32, and the pattern surface 20.

For example, the wide angle lens 12 is provided at the middle between the first mirror surface 31 and the second mirror surface 32. It is desirable for the wide angle lens 12 to be provided at a position that is lower than the height of the first mirror surface 31 and lower than the height of the second mirror surface 32 to squarely face the pattern surface 20. This is elaborated below.

The first mirror surface 31 includes a first end portion 31a and a second end portion 31b. The second end portion 31b is separated from the first end portion 31a in the Z-axis direction. In FIG. 2, the first end portion 31a is the upper end of the first mirror surface 31; and the second end portion 31b is the lower end.

The second mirror surface 32 includes a third end portion 32a and a fourth end portion 32b. The fourth end portion 32b is separated from the third end portion 32a in the Z-axis direction. In FIG. 2, the third end portion 32a is the upper end of the second mirror surface 32; and the fourth end portion 32b is the lower end.

A distance Lb between the pattern surface 20 and the wide angle lens 12 (the position where the lens is mounted to the imaging device) is shorter than a distance La between the pattern surface 20 and the first end portion 31a. The distance Lb is shorter than a distance Lc between the pattern surface 20 and the third end portion 32a. In the example, the distance La is equal to the distance Lc.

It is favorable for an optical axis 12a of the wide angle lens 12 to be oriented along the Z-axis direction. In other words, it is favorable to be perpendicular to the pattern surface 20. For example, the angle between the Z-axis direction and the optical axis 12a is not more than tan⁻¹ (La/Ld). Such a placement angle of the wide angle lens 12 can be set appropriately according to the angle of view of the wide angle lens 12.

FIG. 3 is a block diagram illustrating the calibration device according to the first embodiment.

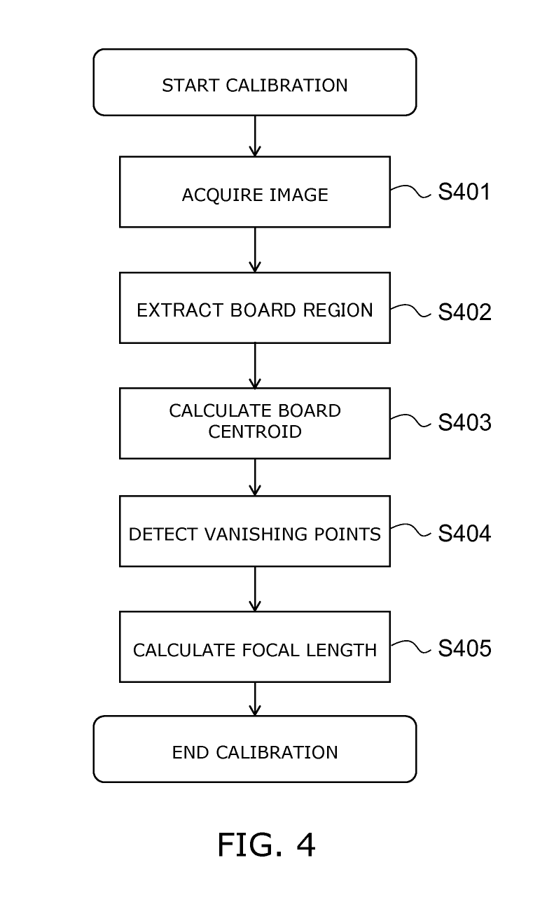

FIG. 4 is a flowchart illustrating the calibration method according to the first embodiment.

As shown in FIG. 3, the calibration device 100a further includes an operation unit 40, an image input unit 45, and a result output unit 46. The operation unit 40 includes a region extractor 41, a centroid position calculator 42, a vanishing point detector 43, and a focal distance calculator 44. The operation unit 40 may include, for example, a computer. The operation unit 40 acquires the first image that is captured by the imaging device 11 and extracts the parameters of the imaging device 11 and the wide angle lens 12.

FIG. 4 is a flowchart showing the calibration method implemented by the operation unit 40. As shown in FIG. 4, the calibration method according to the embodiment includes steps S401 to S405.

In step S401, the calibration device 100a acquires the first image that is captured by the imaging device 11. For example, the image input unit 45 is an interface; and a first image 50 is input from the imaging device 11 to the operation unit 40 by the image input unit 45.

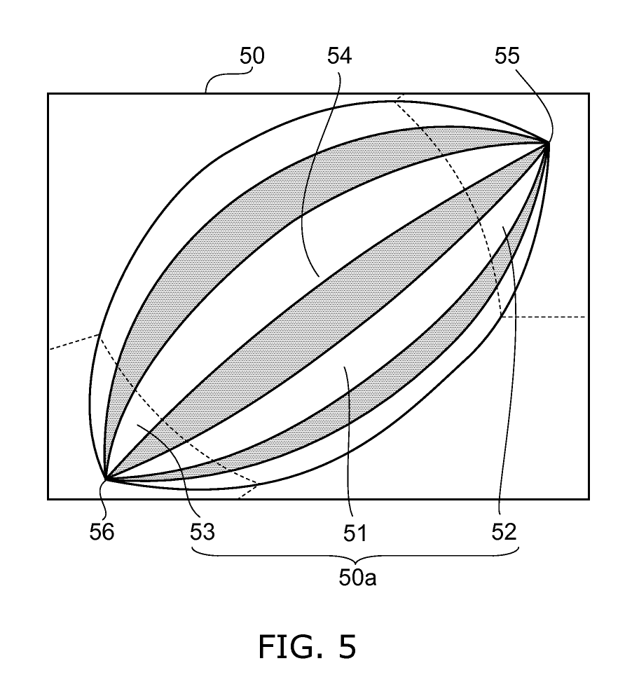

FIG. 5 is a schematic view illustrating the image of the calibration device according to the first embodiment. FIG. 5 shows the first image 50 that is captured by the imaging device 11.

In step S402, a first pattern region 50a (the board region) is extracted from the first image 50. The board region (the first pattern region 50a) corresponds to the calibration board 21 inside the first image 50.

As shown in FIG. 5, the first pattern region 50a includes a first portion 51, a second portion 52, and a third portion 53. The first portion 51 is the portion where the pattern surface 20 appears.

Here, on the first mirror surface 31, a mirror image (a first mirror image) of the pattern surface 20 is formed by the first mirror surface 31. On the second mirror surface 32, a mirror image (a second mirror image) of the pattern surface 20 is formed by the second mirror surface 32.

The second portion 52 is the portion where the first mirror image and the image of the second mirror image appearing on the first mirror surface 31 appear. The third portion 53 is the portion where the second mirror image and the image of the first mirror image appearing on the second mirror surface 32 appear. The first pattern region 50a is a region inside the first image 50 where the first portion 51, the second portion 52, and the third portion 53 appear. The operation unit 40 calibrates the parameters of the imaging device 11 and the wide angle lens 12 based on such a first pattern region 50a.

The operation unit 40 pre-stores the color of the calibration pattern. The extraction of the first pattern region 50a includes extracting based on the stored color of the calibration pattern.

For example, the region having the same color as the stored color of the calibration pattern is extracted from the first image 50. Thereby, the first pattern region 50a can be extracted. Other than using the color, the pattern may be utilized as a feature; and a region having a similar feature may be extracted.

The calibration of the parameters includes detecting a first centroid position 54, a first vanishing point 55, and a second vanishing point 56.

In step S403, the centroid position calculator 42 detects (calculates) the first centroid position 54 where the centroid of the first pattern region 50a is positioned. In step S404, the vanishing point detector 43 detects the first vanishing point 55 and the second vanishing point 56.

The first mirror surface 31 and the second mirror surface 32 are provided in the embodiment. Thereby, for example, the calibration pattern appears to extend to infinity inside the first image 50. The vanishing points correspond to points on the calibration pattern positioned at infinity. In the case where a short calibration board is used without mirrors, such vanishing points cannot be obtained.

The point (the first vanishing point 55) in the first pattern region 50a having the longest distance from the first centroid position 54 is detected. For example, the first vanishing point 55 is the vanishing point of the image corresponding to the mirror image (the first mirror image) formed by the first mirror surface 31.

Among the points in the first pattern region 50a, the coordinates of the point (the pixel) at the position most distal to the centroid position is acquired as the position of the first vanishing point 55. The first vanishing point 55 is the point among the points of the outer circumference of the first pattern region 50a that is most distal to the first centroid position 54.

A vector x is set to be the vector from the first centroid position 54 to the position of the first vanishing point 55. The pixel positions inside the first pattern region 50a are expressed by vectors k from the first centroid position 54. Among the vectors k that have negative inner products with the vector x, the pixel position of the vector k having the maximum absolute value is acquired as the position of the second vanishing point 56.

That is, the point (the second vanishing point 56) in the first pattern region 50a having the longest distance from the first vanishing point 55 is detected. The second vanishing point 56 is the vanishing point of the image corresponding to the mirror image (the second mirror image) formed by the second mirror surface 32.

In other words, the second vanishing point 56 is positioned on the opposite side from the first vanishing point 55 as viewed from the first centroid position 54. The second vanishing point 56 is the point most distal to the first centroid position 54 among the points of the outer circumference of the first pattern region 50a existing on the opposite side from the first vanishing point 55 with the first centroid position 54 interposed.

In step S405, the focal distance calculator 44 calculates the focal length of the wide angle lens 12. For example, in the case of equidistance projection, the focal length is calculated by dividing ½ of the distance between the first vanishing point 55 and the second vanishing point 56 inside the first image 50 by pi. The optical center to be calibrated (the optical center of the first image 50) may be used as the first centroid position 54. The average position between the position of the first vanishing point 55 and the position of the second vanishing point 56 may be used as the optical center. Thus, the parameters are calculated; and the parameters of the imaging device 11 can be calibrated.

For example, in a method of a reference example, the calibration of the imaging device is performed without using a mirror surface. In the method of such a reference example, for example, the vanishing points are detected by imaging the calibration board in which a parallel pattern is drawn and by approximating the configuration of the parallel pattern inside the image as an ellipse. In the case where such an approximation is used, the parallel pattern that is used is long enough for the vanishing points to be captured. Thereby, the precision can be increased; but the device undesirably becomes large. Moreover, an error occurs because the ellipse is used in the estimation.

Conversely, by using the first mirror surface 31 and the second mirror surface 32 in the embodiment, the vanishing points can be calculated using a short calibration board. Thereby, the calibration device can be more compact. Even in the case where the short calibration board is used, for example, the points corresponding to infinity can be detected. Thereby, the precision can be increased.

### SECOND EMBODIMENT

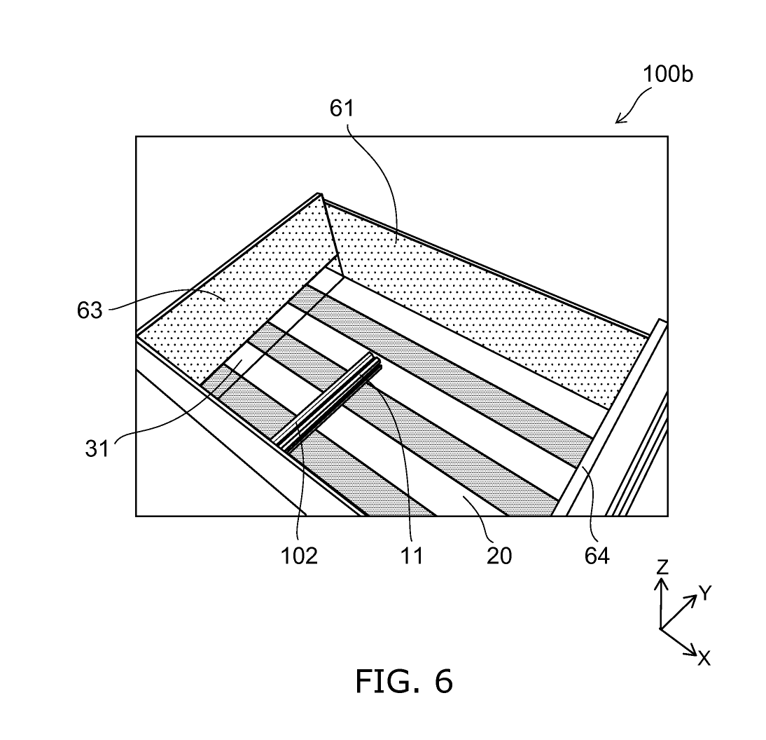

FIG. 6 is a schematic perspective view illustrating a calibration device according to a second embodiment.

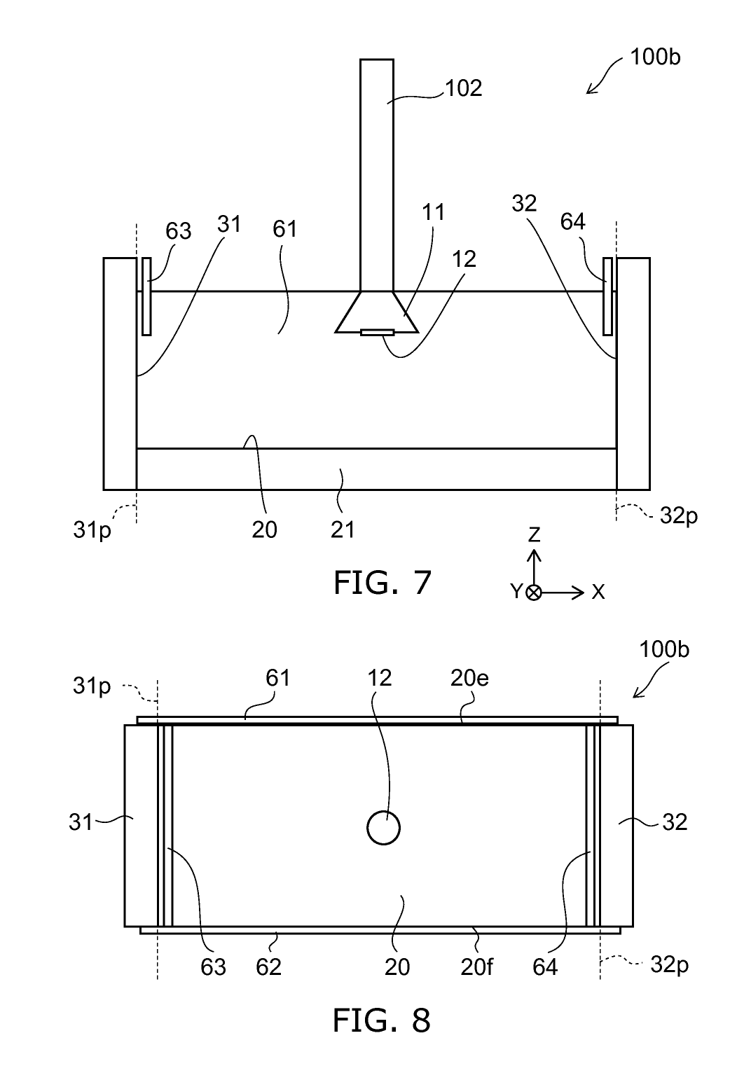

FIG. 7 is a schematic side view illustrating the calibration device according to the second embodiment.

FIG. 8 is a schematic plan view illustrating the calibration device according to the second embodiment.

For example, as shown in FIGS. 6 to 8, the calibration device 100b according to the second embodiment includes a first wall 61, a second wall 62, a third wall 63, and a fourth wall 64. Otherwise, a description similar to the description of the calibration device 100a is applicable to the calibration device 100b.

The colors of the first wall 61 and the second wall 62 are different from the color of the calibration pattern. In the example, the color is red (a first color) for the first wall 61 and the second wall 62.

The first wall 61 and the second wall 62 intersect the pattern surface 20 and extend in the X-axis direction. The first wall 61 and the second wall 62 intersect the first surface 31p (or the first mirror surface 31) and the second surface 32p (or the second mirror surface 32). The second wall 62 is separated from the first wall 61 in the Y-axis direction. The wide angle lens 12 is placed between the first wall 61 and the second wall 62 as viewed from the Z-axis direction.

In the embodiment, it is sufficient for the state of intersecting to be a state that can be considered to be substantially intersecting for the calibration and includes, for example, the state in which a small gap (e.g., a gap not more than about 5 mm) occurs between the surfaces.

The pattern surface 20 has an edge 20e (a side) and an edge 20f. The edge 20e and the edge 20f are separated from each other in the Y-axis direction. The edge 20e and the edge 20f are provided from the first surface 31p to the second surface 32p. The first wall 61 intersects the entire edge 20e; and the second wall 62 intersects the entire edge 20f. In other words, the first wall 61 and the second wall 62 are placed to completely occupy the edges of the mirror surfaces and the edges of the pattern surface 20 not contacting the mirror surfaces.

The third wall 63 is provided between the first mirror surface 31 and the wide angle lens 12. The fourth wall 64 is provided between the second mirror surface 32 and the wide angle lens 12. The third wall 63 and the fourth wall 64 are mirror shields. The mirror shields cover a portion of at least one of the first mirror surface 31 or the second mirror surface 32.

The mirror shields do not cover the mirror surfaces provided at positions lower than the height (the distance along the Z-axis direction measured from the pattern surface 20) of the wide angle lens 12. In other words, the distance between the pattern surface 20 and the wide angle lens 12 is shorter than the distance between the pattern surface 20 and the third wall 63. The distance between the pattern surface 20 and the wide angle lens 12 is shorter than the distance between the pattern surface 20 and the fourth wall 64.

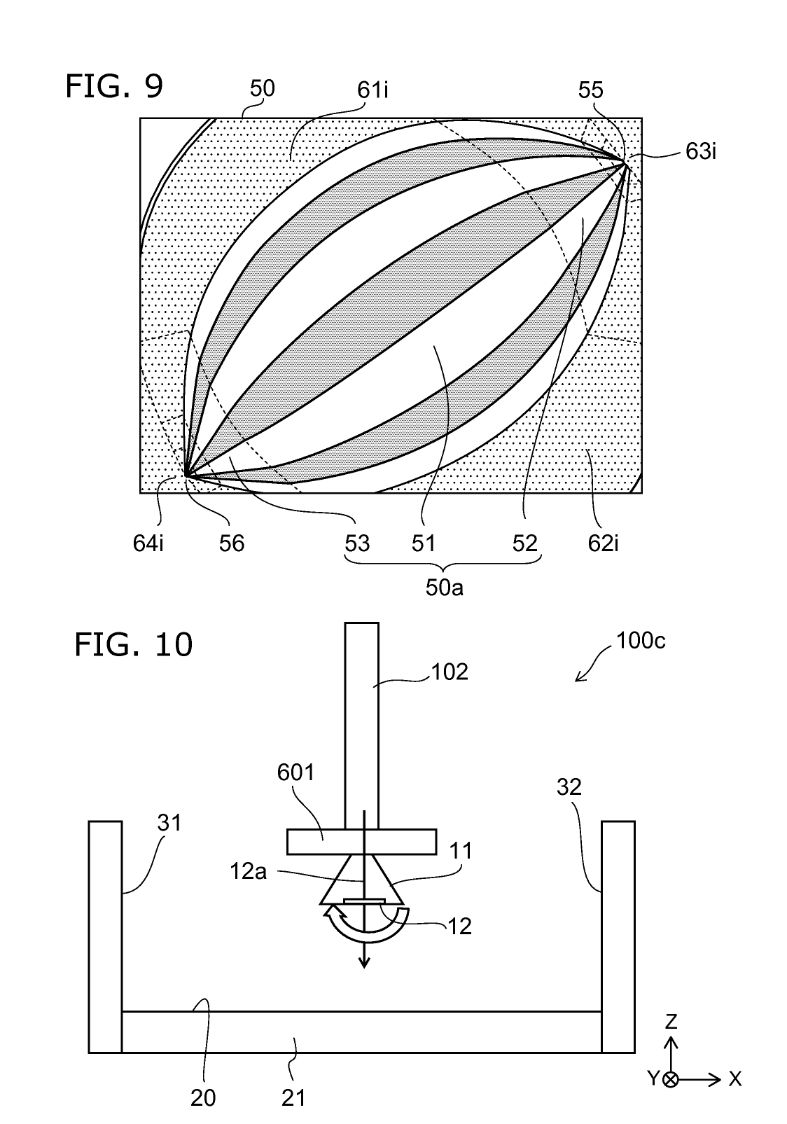

FIG. 9 is a schematic view illustrating the image of the calibration device according to the second embodiment.

FIG. 9 shows the image (the first image 50) that is captured by the imaging device 11. As shown in FIG. 9, the first image includes an image 61i of the first wall, an image 62i of the second wall, an image 63i of the third wall, and an image 64i of the fourth wall. The images 61i, 62i, 63i, and 64i are provided around the first pattern region 50a.

The image 61i of the first wall is the portion where the first wall 61 and the mirror image of the first wall 61 appear. The image 62i of the second wall is the portion where the second wall 62 and the mirror image of the second wall 62 appear.

The first pattern region 50a is positioned between the image 61i of the first wall and the image 62i of the second wall.

Thus, a region having the first color that is different from that of the calibration pattern is provided around the first pattern region 50a. Thereby, in step S401 described above, the precision can be increased when extracting the first pattern region 50a based on the colors.

The positions of the mirror shields (the third wall 63 and the fourth wall 64) described above may be modified appropriately so that the region having the first color is provided around the first pattern region 50a.

### THIRD EMBODIMENT

FIG. 10 is a schematic side view illustrating a calibration device according to a third embodiment.

As shown in FIG. 10, the calibration device 100c includes a rotation mechanism 601 (a rotation unit). Otherwise, a description similar to the description of the calibration device 100a is applicable to the calibration device 100c.

The rotation mechanism 601 rotates the imaging device 11 using the optical axis 12a of the wide angle lens 12 as the rotation axis. Thereby, an incident direction DL of the light incident on the wide angle lens 12 from the pattern surface 20 can be changed.

The rotation mechanism 601 may include any form such as a shaft, a bearing, a screw, etc., and may be manual or electric. The imaging device 11 may be rotated and adjusted so that the first and second vanishing points are positioned at the opposite corners of the image. Thereby, for example, the detection precision increases.

Although the optical axis 12a is used as the rotation axis in the example, tilting of the rotation axis from the optical axis 12a is tolerable as long as the incident direction DL can be rotated.

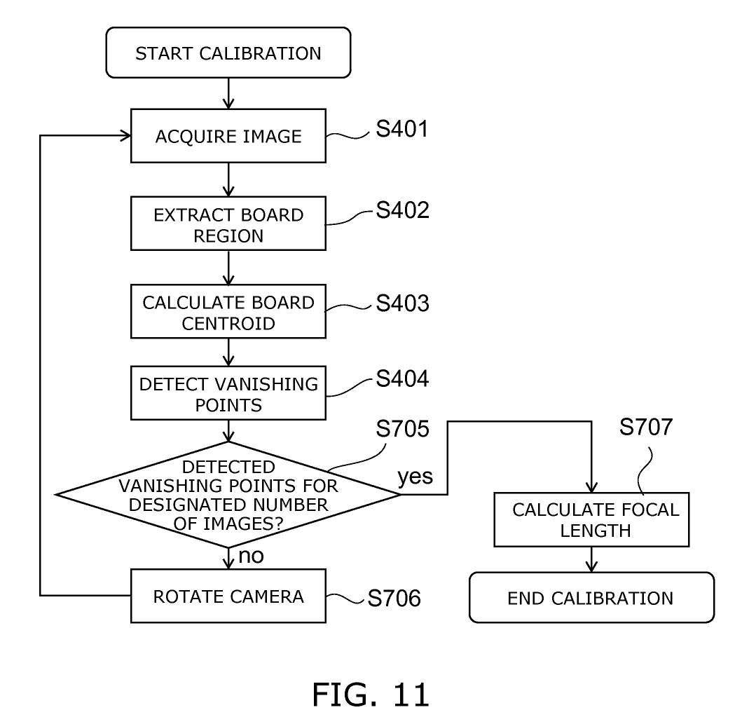

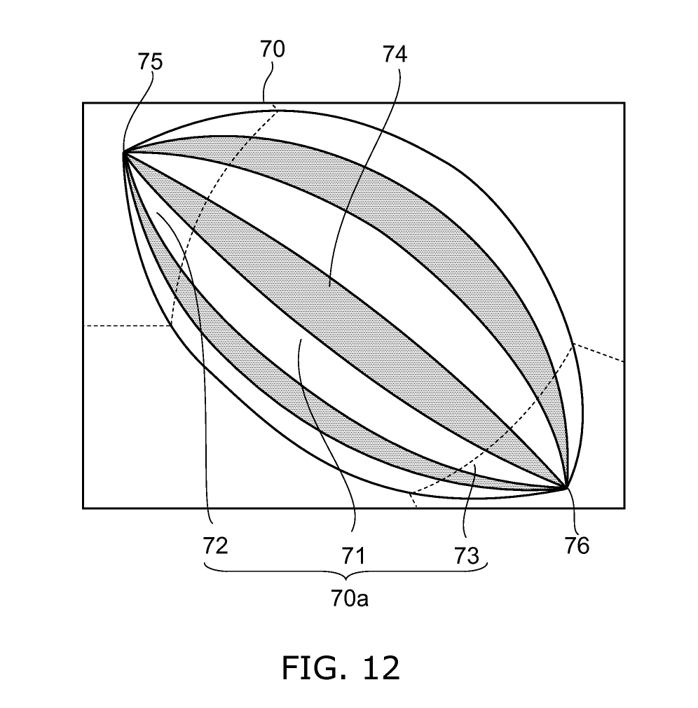

FIG. 11 is a flowchart illustrating the calibration method according to the third embodiment.

The calibration method shown in FIG. 11 is implemented by the operation unit 40 and includes steps S401 to S404 and steps S705 to S707 similarly to the first embodiment.

Similarly to the first embodiment, the first image 50 is processed in steps S401 to S404. Here, the first image 50 is the image that is captured by the imaging device 11 when the incident direction DL is a first incident direction.

In step S705, it is confirmed whether or not the number of images for which the vanishing point detection is performed is a prescribed number. In the case where the number of images is not the prescribed number, step S706 is implemented.

In step S706, the imaging device 11 is rotated by the rotation mechanism 601. After the rotation, the imaging device 11 further images an image (a second image 70). The second image 70 is captured by the imaging device 11 when the incident direction DL is a second incident direction that is different from the first incident direction.

FIG. 12 is a schematic view illustrating the image that is imaged by the calibration device according to the third embodiment.

Step S401 to step S404 are further implemented for the second image 70 shown in FIG. 12. In step S401, the operation unit 40 acquires the second image 70.

In step S402, a second pattern region 70a inside the second image 70 is extracted. The second pattern region 70a includes portions 71 to 73. The portion 71 is the portion where the pattern surface 20 appears. The portion 72 is the portion where the mirror image (a third mirror image) of the pattern surface 20 formed on the first mirror surface 31 appears. The portion 73 is the portion where the mirror image (a fourth mirror image) of the pattern surface 20 formed on the second mirror surface 32 appears.

In step S403, a second centroid position 74 is detected where the centroid of the second pattern region 70a is positioned.

In step S404, a third vanishing point 75 and a fourth vanishing point 76 are detected. The third vanishing point 75 is the point among the points in the second pattern region 70a that has the longest distance from the second centroid position 74. The fourth vanishing point 76 is the point among the points in the second pattern region 70a that has the longest distance from the third vanishing point 75.

Step S707 is implemented in the case where the number of images for which the vanishing point detection is performed is the prescribed number. In step S707, the focal length and the optical center are determined by utilizing the positions of the vanishing points obtained for each image. The intersection between a first line segment connecting the first vanishing point 55 and the second vanishing point 56 of the first image 50 and a second line segment connecting the third vanishing point 75 and the fourth vanishing point 76 of the second image 70 is calculated and used as the image center. In the case of equidistance projection, the value of ½ of the average of the length of the first line segment and the length of the second line segment divided by pi is calculated as the focal length. The precision of the calibration can be increased by calculating the parameters using multiple images.

Although the imaging device 11 is mounted to the placing unit 102 in the example described above, the imaging device 11 may be mounted to an automobile or an aircraft. For example, the imaging device may be a rear view camera mounted to a vehicle body. In such a case, the calibration device is mounted to the vehicle body; and the calibration is performed. Thereby, a high-precision calibration can be performed easily. In such a case, it is favorable for the relative positional relationship between the calibration device and the imaging device to be similar to the positional relationship described in regard to FIG. 2. Therefore, the configuration of the device may be modified appropriately to match the configuration of the vehicle body.

The operation unit 40 according to the embodiment may include, for example, a processing circuit 83, memory 84, etc. The processing circuit 83 may include, for example, a controller such as a CPU (Central Processing Unit), etc., an integrated circuit such as LSI (Large Scale Integration), etc., an IC (Integrated Circuit) chipset, etc. The processing circuit 83 and the memory 84 may be provided on one substrate; and at least a portion may be provided separately. The integrated circuit is not limited to LSI; and a dedicated circuit or a general-purpose processor may be used. The processing circuit 83 and the memory 84 may have a hardware configuration utilizing a normal computer. Each component of the operation unit 40 described above may be software or hardware. In the embodiment, the processing of each functional block may be a program implemented by a computer.

The memory 84 may include a memory device such as ROM, RAM, etc. An external memory device such as a HDD, a SSD, etc., may be used. The memory 84 stores the image that is captured by the imaging device, the calculation result, etc.

The memory 84 may store a program that causes a computer, etc., to execute the calibration method according to the embodiment. For example, the program is read and the image processing is executed by the processing circuit 83. The program may be provided in the state of being pre-stored in the memory 84, may be provided via an external storage medium or a network, or may be installed as appropriate.

Although the calibration method and the calibration device are described in the embodiments recited above, the embodiments may be in the form of a calibration program for causing a computer to execute the calibration method, or the form of a computer-readable recording medium in which the calibration program is recorded.

Specifically, CD-ROM (-R/-RW), a magneto-optical disk, a HD (a hard disk), DVD-ROM (-R/-RW/-RAM), a FD (flexible disk), flash memory, a memory card, a memory stick, other various ROM, RAM, etc., may be used as the recording medium recited above; and the method is easy to realize by recording the calibration program for causing the computer to execute the calibration method of the embodiment described above in such a recording medium and by distributing the recording medium. The calibration method of the embodiment can be executed by mounting the recording medium recited above to an information processing device such as a computer, etc., and by the information processing device reading the calibration program, or by storing the calibration program in a storage medium included in the information processing device and reading the calibration program as necessary.

According to the embodiments, a calibration method, a calibration program, and a compact calibration device that have high precision can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components such as the calibration pattern, the first mirror surface, the second mirror surface, the operation unit, the first to fourth walls, the placing unit etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all calibration methods, non-transitory recording mediums and calibration devices practicable by an appropriate design modification by one skilled in the art based on the calibration methods, the non-transitory recording mediums and the calibration devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A calibration method, comprising:
acquiring a first image captured by an imaging device including a wide angle lens, at least a portion of a pattern surface being projected to the first image, at least a portion of a first mirror surface provided on a first surface being projected to the first image, at least a portion of a second mirror surface provided on a second surface being projected to the first image, a calibration pattern being provided in the pattern surface, the first surface intersecting the pattern surface, the second surface intersecting the pattern surface and being parallel to the first surface, the second mirror surface opposing the first mirror surface;
extracting a part of the first image where the pattern surface is projected as a first pattern region, a first mirror image of the pattern surface formed on the first mirror surface appearing in the first pattern region, a second mirror image of the pattern surface formed on the second mirror surface appearing in the first pattern region; and
calibrating a parameter of the imaging device based on the first pattern region, the parameter including a focal length of the wide angle lens.

2. The method according to claim 1, wherein
the calibrating includes:
detecting a first centroid position of a centroid of the first pattern region;
detecting a first vanishing point of an image corresponding to the first mirror image in the first pattern region; and
detecting a second vanishing point of an image corresponding to the second mirror image in the first pattern region.

3. The method according to claim 1, wherein the calibration pattern includes a pattern having a side extending in a first direction from the first mirror surface toward the second mirror surface.

4. The method according to claim 1, wherein the extracting includes extracting the first pattern region based on a color of the calibration pattern.

5. The method according to claim 1, wherein the wide angle lens is provided between the first mirror surface and the second mirror surface.

6. The method according to claim 1, wherein
the imaging device is mounted to a placing unit provided at a position where the placing unit is not projected to the first image, and
the placing unit regulates a position of the wide angle lens with respect to the pattern surface.

7. The method according to claim 1, wherein
the first image includes an image of a first wall and an image of a second wall,
the first wall intersects the pattern surface and extends in a first direction from the first mirror surface toward the second mirror surface,
a color of the first wall is different from a color of the calibration pattern,
the second wall intersects the pattern surface, extends in the first direction, and is separated from the first wall,
a color of the second wall is different from the color of the calibration pattern, and
the first pattern region is positioned between the image of the first wall and the image of the second wall.

8. The method according to claim 7, wherein
the first image further includes an image of a third wall,
the third wall is provided between the first mirror surface and the second mirror surface in the first direction,
a color of the third wall is different from the color of the calibration pattern,
a distance between the pattern surface and the wide angle lens is shorter than a distance between the pattern surface and the third wall.

9. The method according to claim 2, wherein an incident direction of light incident on the wide angle lens from the pattern surface is changeable.

10. The method according to claim 9, wherein
the first image is captured by the imaging device when the incident direction is a first incident direction, and
the method further includes:
acquiring a second image captured by the imaging device when the incident direction is a second incident direction different from the first incident direction;
extracting a second pattern region inside the second image, the pattern surface appearing in the second image, a third mirror image of the pattern surface formed on the first mirror surface appearing in the second image, a fourth mirror image of the pattern surface formed on the second mirror surface appearing in the second image;
detecting a second centroid position, a third vanishing point on the second pattern region, and a fourth vanishing point on the second pattern region, a centroid of the second pattern region being positioned at the second centroid position, the third vanishing point having the longest distance to the second centroid position, the fourth vanishing point having the longest distance to the third vanishing point; and
calculating an intersection between a straight line connecting the first vanishing point and the second vanishing point and a straight line connecting the third vanishing point and the fourth vanishing point.

11. A non-transitory recording medium recording a calibration program of an imaging device including a wide angle lens, the program causing a computer to execute processing including:
acquiring a first image captured by the imaging device, at least a portion of a pattern surface being projected to the first image, at least a portion of a first mirror surface provided on a first surface being projected to the first image, at least a portion of a second mirror surface provided on a second surface being projected to the first image, a calibration pattern being provided in the pattern surface, the first surface intersecting the pattern surface, the second surface intersecting the pattern surface and being parallel to the first surface, the second mirror surface opposing the first mirror surface;
extracting a part of the first image where the pattern surface is projected as a first pattern region, a first mirror image of the pattern surface formed on the first mirror surface appearing in the first pattern region, a second mirror image of the pattern surface formed on the second mirror surface appearing in the first pattern region; and
calibrating a parameter of the imaging device based on the first pattern region, the parameter including a focal length of the wide angle lens.

12. The non-transitory recording medium according to claim 11, wherein the calibrating includes:
detecting a first centroid position of a centroid of the first pattern region;
detecting a first vanishing point of an image corresponding to the first mirror image in the first pattern region; and
detecting a second vanishing point of an image corresponding to the second mirror image in the first pattern region.

13. The non-transitory recording medium according to claim 11, wherein
the calibration pattern includes a pattern having a side extending in a first direction from the first mirror surface toward the second mirror surface, and
the extracting includes extracting the first pattern region based on a color of the calibration pattern.

14. A calibration device, comprising:
a pattern surface, a calibration pattern being provided in the pattern surface;
a first mirror surface provided on a first surface intersecting the pattern surface; and
a second mirror surface provided on a second surface to oppose the first mirror surface, the second surface intersecting the pattern surface and being parallel to the first surface,
the device being capable of placing a wide angle lens of an imaging device at a position between the first mirror surface and the second mirror surface, the position being separated from the pattern surface,
the device being used to calibrate a parameter of the imaging device based on a first image captured by the imaging device.

15. The device according to claim 14, further comprising an operation unit,
the operation unit acquiring the first image captured by the imaging device, at least a portion of the pattern surface appearing in the first image, at least a portion of the first mirror surface appearing in the first image, at least a portion of the second mirror surface appearing in the first image,
the operation unit extracting a part of the first image where the pattern surface is projected as a first pattern region, a first mirror image of the pattern surface formed on the first mirror surface appearing in the first pattern region, a second mirror image of the pattern surface formed on the second mirror surface appearing in the first pattern region,
the operation unit calibrating, based on the first pattern region, a parameter of the imaging device including a focal length of the wide angle lens.

16. The device according to claim 15, wherein the calibrating includes:
detecting a first centroid position of a centroid of the first pattern region;
detecting a first vanishing point of an image corresponding to the first mirror image in the first pattern region; and
detecting a second vanishing point of an image corresponding to the second mirror image in the first pattern region.

17. The device according to claim 14, further comprising a placing unit provided at a position where the placing unit does not appear in the first image,
the imaging device being mounted to the placing unit,
the placing unit regulating a position of the wide angle lens with respect to the pattern surface.

18. The device according to claim 14, further comprising:
a first wall intersecting the pattern surface and extending in a first direction from the first mirror surface toward the second mirror surface; and
a second wall intersecting the pattern surface and extending in the first direction, the second wall being separated from the first wall,
a color of the first wall and a color of the second wall being different from a color of the calibration pattern,
the first image including an image of the first wall and an image of the second wall,
the first pattern region being positioned between the image of the first wall and the image of the second wall.

19. The device according to claim 18, further comprising a third wall provided between the first mirror surface and the second mirror surface in the first direction,
a color of the third wall being different from the color of the calibration pattern,
a distance between the pattern surface and the wide angle lens being shorter than a distance between the pattern surface and the third wall.

20. The device according to claim 14, wherein an incident direction of light incident on the wide angle lens from the pattern surface is changeable.
